(19) United States
(12) Patent Application Publication
(10) Pub. No.: US 2019/0026389 A1
(43) Pub. Date: Jan. 24, 2019

(54) POST-PROCESSOR FOR COLLECTING RELATED FACTOID ANSWERS INTO A SINGLE OBJECT

(71) Applicant: INTERNATIONAL BUSINESS MACHINES CORPORATION, ARMONK, NY (US)

(72) Inventors: Charles E. Beller, Baltimore, MD (US); Paul J. Chase, JR., Fairfax, VA (US); Richard L. Darden, Leesburg, VA (US); Michael Drzewucki, Woodbridge, VA (US); Edward G. Katz, Washington, DC (US); Christopher Phipps, Arlington, VA (US)

(21) Appl. No.: 15/657,977

(22) Filed: Jul. 24, 2017

(51) Int. Cl. G06F 17/30; G06N 5/02

(52) U.S. Cl. CPC G06F 17/30979; G06N 5/022

(57) ABSTRACT

A method, computer system, and a computer program product for collecting related factoid answers into a single object is provided. The present invention may include identifying an informativeness criteria. The present invention may also include identifying a query. The present invention may then include receiving a plurality of answer terms. The present invention may then include generating a plurality of informative factoid answers. The present invention may then include identifying a plurality of relation-bearing elements. The present invention may then include grouping the plurality of informative factoid answers into a single object. The present invention may then include generating a plurality of relations from the plurality of informative factoid answers and the plurality of relation-bearing elements. The present invention may further include creating a plurality of knowledge base entries from the plurality of relations. The present invention may also include storing the plurality of knowledge entries in a knowledge base.

### STATEMENT REGARDING FEDERALLY SPONSORED RESEARCH OR DEVELOPMENT

This invention was made with Government support. The Government has certain rights in this invention.

### BACKGROUND

The present invention relates generally to the field of computing, and more particularly to computational linguistics.

Question answering (QA) systems find terms that are related to each other. However, such terms are later discarded. Unless the informative data is categorized as a correct answer, the data that is discovered during the QA process is not identified and stored for future queries.

### SUMMARY

Embodiments of the present invention disclose a method, computer system, and a computer program product for collecting related factoid answers into a single object. The present invention may include identifying an informativeness criteria. The present invention may also include identifying a query entered by a user. The present invention may then include receiving a plurality of answer terms generated by an answer generator. The present invention may then include generating a plurality of informative factoid answers based on the received plurality of answer terms to the identified query. The present invention may then include identifying a plurality of relation-bearing elements based on the identified query. The present invention may then include grouping the generated plurality of informative factoid answers into a single object, wherein the generated plurality of informative factoid answers is derived from the received plurality of answer terms. The present invention may then include generating a plurality of relations from the grouped plurality of informative factoid answers and the corresponding identified plurality of relation-bearing elements. The present invention may further include creating a plurality of knowledge base entries from the generated plurality of relations. The present invention may also include storing the created plurality of knowledge entries in a knowledge base.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for factoid answer collection according to at least one embodiment;

FIG. 3 is a block diagram of internal and external components of computers and servers depicted in FIG. 1 according to at least one embodiment;

FIG. 4 is a block diagram of an illustrative cloud computing environment including the computer system depicted in FIG. 1, in accordance with an embodiment of the present disclosure; and

FIG. 5 is a block diagram of functional layers of the illustrative cloud computing environment of FIG. 4, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for collecting related factoid answers into a single object. As such, the present embodiment has the capacity to improve the technical field of computational linguistics by grouping and storing semantically informative terms as a single object into a structured relation in various forms (e.g., Resource Description Framework triples (RDF Triples), or knowledge graph) in a knowledge base. More specifically, the user may select a criteria for informativeness to determine whether the generated answer terms best answers to the received query. Next, the factoid answer collection program may identify the query entered by the user and the list of answer terms generated by a known answer generator (e.g., Watson Discovery Advisor™, Watson Discovery Advisor and all Watson Discovery Advisor-based trademarks and logos are trademarks or registered trademarks of International Business Machines Corporation and/or its affiliates). Then, the list of answer terms may be compared with the criteria for informativeness and all answer terms that fail to satisfy the criteria may be excluded from the list of informative factoid answers. Then, the factoid answer collection program may identify the relation-bearing elements in the query, and the informative factoid answers may be grouped into a single object. Then, a relation may be generated to identify the relationship between the informative factoid answers and the relation-bearing element in the query. The informative factoid answers may be grouped together with the relation name and the relation-bearing element in the query to create a new knowledge base entry that may be stored in a knowledge base for future queries.

As described previously, question answering (QA) systems find terms that are related to each other, but then discard those terms. Unless the informative data is categorized as a correct answer, the data that is discovered during the QA process is not identified and stored for future queries.

Therefore, it may be advantageous to, among other things, provide a method, computer system or computer program product for identifying when a QA system has discovered terms with some relation to each other and then collecting those answer terms into a single object that can be stored in a knowledge base. This allows reuse of the discovered relationship information at a future time.

According to at least one embodiment, the factoid answer collection program may include a rule-based system or machine learning based system to extract answers to queries, generate a relation between grouped informative answer terms and relation-bearing elements from the query, and then store the generated relation in the structured knowledge base for later purposes (e.g., visualization or more question answering). The queries are received by a user and the answer terms are generated by multiple known answer generators (e.g., Watson Discovery Advisor™). The factoid answer collection program may also obtain extracted answers to queries from a corpus of documents, even if the extracted answer is located in a different passage or document from the query.

According to at least one embodiment, answer generators may be utilized to generate the answer terms to the received query. For a given query, the answer generators may generate answer terms based on the corpus of documents (e.g., publications, literature, credible online sources, or manually uploaded texts) stored within the database of the answer generator. The corpus of documents may be ingested by the answer generator and text may be extracted from the corpus documents to provide answers terms to a query. Then, the extracted text may be stored in a database for future queries. As such, when an answer generator receives a query, the answer generator may search the database for any answer terms to the received query that may have been previously stored in the database.

According to at least one embodiment, the factoid answer collection program may discover a constellation of answer terms that may have meaningful relation to the answer terms to the query. As such, the factoid answer collection program may be more generalized than just listing queries. Furthermore, the factoid answer collection program may accept multiple forms for the query (e.g., overtly signaling that there are multiple answers, or directed to one correct answer). As such, the factoid answer collection program may include less explicit cues in the surface form of the query.

According to at least one embodiment, the factoid answer collection program may naturally adapt a knowledge base to the domain of the users to expand the knowledge base in response to the types of entities and events that are the subject of the users' queries. For example, if the user only enters queries on baseball, then the knowledge base may be primarily generated with information related to baseball.

According to at least one embodiment, the factoid answer collection program may transform a typical QA process into an automated knowledge base expander. The factoid answer collection program may be applied before the highly informative answers are filtered out of the list of answer terms and lost (i.e., answer filtering). As such, the factoid answer collection program may lead to identifying such highly informative answers and storing such answers in a knowledge base without affecting user experience.

According to at least one embodiment, the factoid answer collection program may identify a criteria for informativeness. The factoid answer collection program may utilize various techniques to determine the informativeness of the answers generated by the answer generators, such as confidence scores and shared information content. The QA system may generate a confidence score for each of the answer terms to the received query. The confidence score may range from 0%-100%, or some range that may be normalized to 0%-100%, in which a higher percentage indicates a higher possibility that the answer terms may correspond with the received query. As such, the higher the confidence score, then higher the informativeness of the answer term. Since similar words may have different interpretations depending on the domain, shared information content is a known term in linguistics in which the corpus of documents that information is derived from may be analyzed to determine how words appear together. A shared information content score may be generated for each answer to indicate the informativeness of the answer term to the received query. Additionally, other techniques, such as shared historical relationships (i.e., words with similar linguistic history may be considered semantically similar and more informative), may be utilized to determine the informativeness for each of the answer terms.

According to at least one embodiment, the factoid answer collection program may identify the relation-bearing elements in the query. The factoid answer collection program may utilize various techniques to determine the relation-elements in the query, such as any or all named entities or real-world objects (e.g., places or persons).

According to at least one embodiment, the factoid answer collection program may group informative factoid answers into a single object. The factoid answer collection program may utilize various techniques to group informative factoid answers, such as string concatenation (i.e., operation of joining character strings end-to-end in formal language theory and computer programming), vectors (i.e., array of terms), or relate each informative factoid answer to the others by way of the relation-bearing element from the query.

According to at least one embodiment, the factoid answer collection program may generate a relation between grouped informative factoid answers and relation-bearing elements from the query. The factoid answer collection program may utilize various techniques (e.g., RDF Triples, and nodes and edges in a graph) to generate the relation. RDF Triples may be stored in a type of Structured Query Language (SQL) database that includes three components; two objects and a relation name. RDF Triples may include a relation-bearing element in the query as one of the objects and the informative factoid answer group as the other object. Additionally, the relation may be generated as a graphical database (e.g., knowledge graph) with nodes and edges. One node may represent a relation-bearing element in the query and another node may represent the informative factoid answer group, and the edge (or connecting line between the nodes) may represent the relation name.

According to at least one embodiment, the technique utilized to group the informative factoid answers and to generate relation in the knowledge base may depend on the QA system selected by the user. Different QA systems may utilize different techniques to group informative factoid answers and generate a relation to store in the knowledge base.

According to at least one embodiment, the factoid answer collection program may be integrated into a QA system without a knowledge base. The factoid answer collection program may create the knowledge base for the data generated by the QA system. Thereafter, the QA system may present answer terms to the query entered by the user as an input into the answer generator.

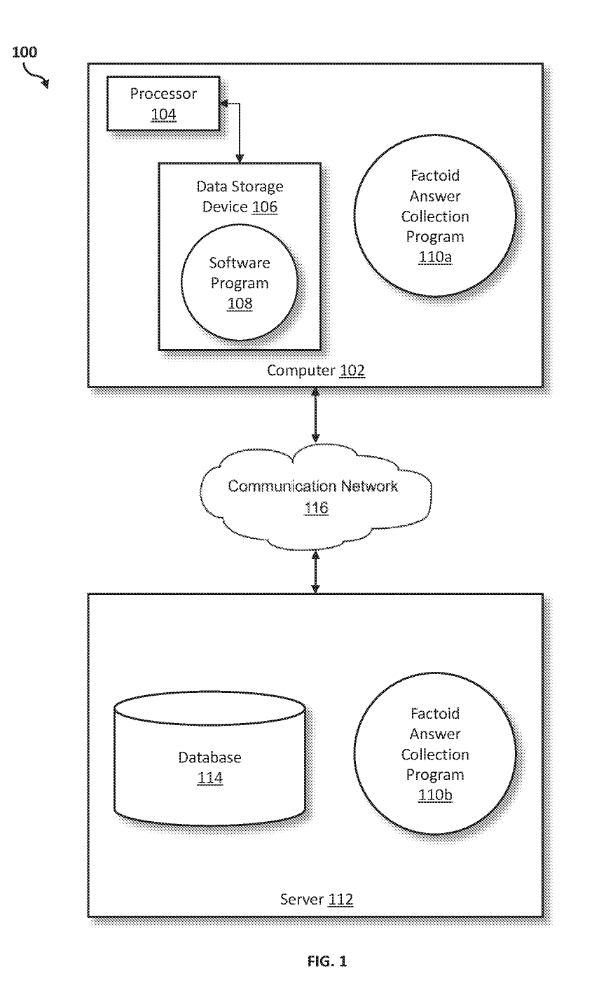

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a factoid answer collection program 110a. The networked computer environment 100 may also include a server 112 that is enabled to run a factoid answer collection program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

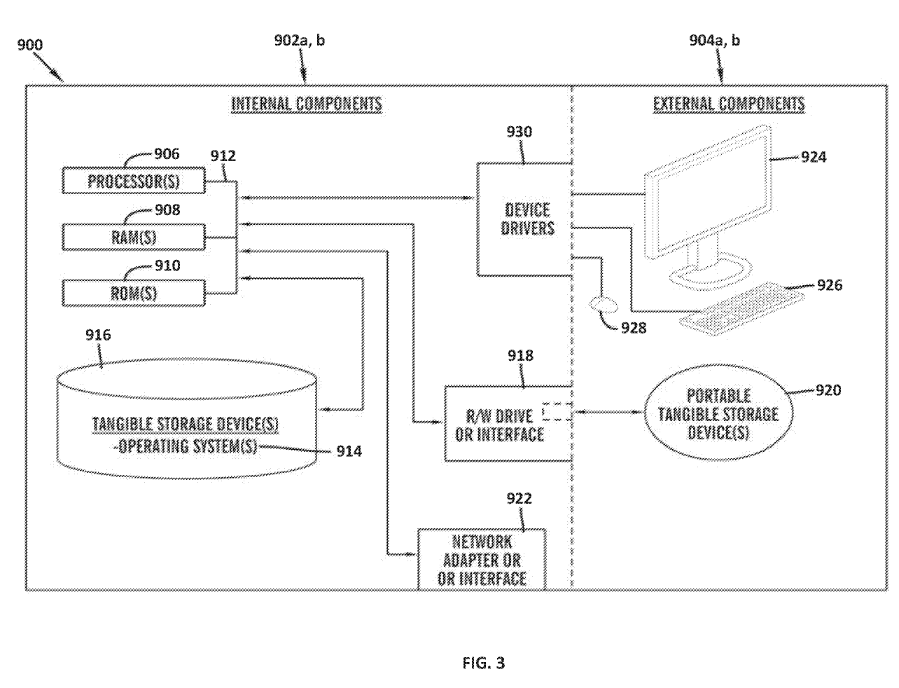

The client computer 102 may communicate with the server computer 112 via the communications network 116. The communications network 116 may include connections, such as wire, wireless communication links, or fiber optic cables. As will be discussed with reference to FIG. 3, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the factoid answer collection program 110a, 110b may interact with a database 114 that may be embedded in various storage devices, such as, but not limited to a computer/mobile device 102, a networked server 112, or a cloud storage service.

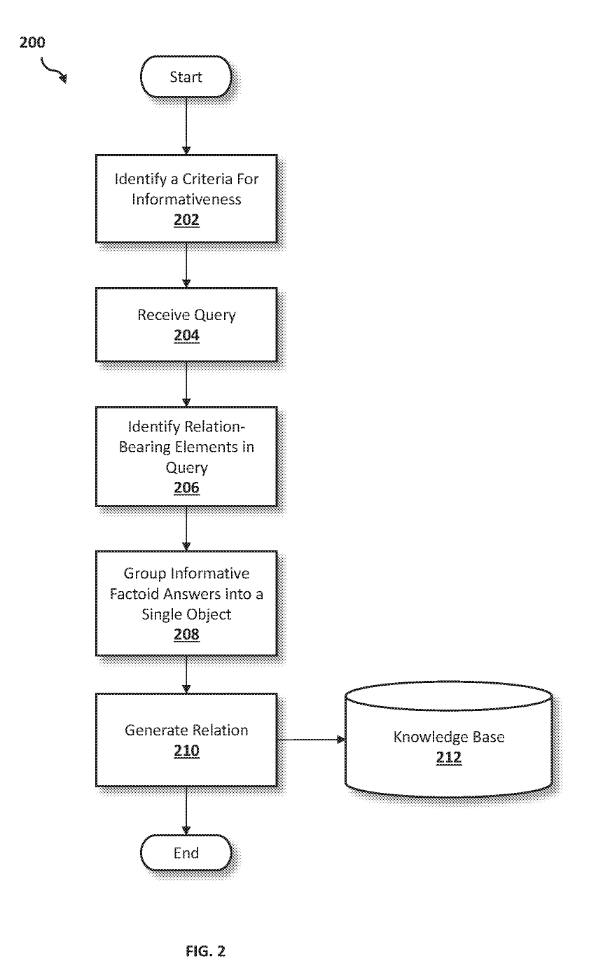

According to the present embodiment, a user using a client computer 102 or a server computer 112 may use the factoid answer collection program 110a, 110b (respectively) to collect related factoid answers into a single object. The factoid answer collection method is explained in more detail below with respect to FIG. 2.

Referring now to FIG. 2, an operational flowchart illustrating the exemplary factoid answer collection process 200 used by the factoid answer collection program 110a and 110b according to at least one embodiment is depicted.

At 202, the factoid answer collection program 110a, 110b identifies a criteria for informativeness for the generated answer terms. The user may select a criteria for determining the informativeness of the answer terms, generated by the answer generators, to the received query. The criteria for informativeness may be generated by various techniques, such as confidence score, shared information content or shared historical relationship. Depending on the answer generator utilized to generate the answer terms to the received query, the techniques (e.g., confidence score, shared information content or shared historical relationship) may be generated by the answer generator or another known external engine that is compatible with the answer generator. Based on the criteria for informativess selected by the user, the answer generator may either provide the requested information for criteria for informativeness with the list of answer terms, or any external engine may generate the requested information after the answer terms have been determined by the answer generator.

At the bottom of the screen displaying a graphical user interface to a user, there may be a “Informativeness Criteria” button. Once the user clicks the “Informativeness Criteria” button, a dialog box, for example, may appear in which the techniques for determining the criteria for informativeness may be presented. The techniques generated may be based on the answer generator utilized by the factoid answer collection program 110a, 110b, since certain answer generators may include certain techniques (e.g., confidence score) or may be compatible with certain techniques for determining the criteria for informativeness. The user may select from the list of generated techniques by clicking the appropriate technique and may then select the “Submit” button located at the bottom of the dialog box. After clicking the “Submit” button, the dialog box may disappear. The factoid answer collection program 110a, 110b may utilize the selected technique to determine the criteria for informativeness.

Additionally, if the criteria for informativeness is determined with a numeric value (i.e., confidence score or shared information content score), then the user may select a threshold for the criteria for informativeness. To be included in the list of informative factoid answers that creates a new knowledge base entry (i.e., entry), the generated answer terms may have to satisfy the threshold for the criteria for informativeness. If the criteria for informativeness is determined with a non-numeric value, then other methods may be utilized to determine whether the criteria for informativeness is satisfied.

If the technique for determining the criteria for informativeness is a numeric value, then another dialog box, for example, may appear after the user clicks the “Submit” button to select the technique for determining the criteria for informativeness. The next dialog box may include a list of possible thresholds (e.g., 50%, 75+%, 90%). Each threshold option may have a box located to the left in which the user may click to select that option for determining the threshold. A “Submit” button may be located at the bottom of the dialog box in which the user may click to complete the selection. After clicking the “Submit” button, the dialog box may disappear. The threshold may then be included in the criteria for informativeness, and the criteria for informativeness may be based on the technique and threshold selected by the user.

For example, the user selects the “Informativeness Criteria” button located at the bottom of the screen. Once a dialog box appears, the user selects the confidence score as the criteria to determine the informativeness of the answer terms, and clicks the “Submit” button at the bottom of the dialog box to save this selection. Since the confidence score is based on a numeric value, the factoid answer collection program 110a, 110b presents another dialog box to determine the threshold. The dialog box includes several options (e.g., 35%, 50%, 75% and 90%) to determine the threshold for the criteria for informativeness. The user further decides that only high-confidence answer terms, such as answer terms with a confidence score of at least 50%, will satisfy the criteria for informativeness, and therefore, the user selects the 50% threshold option. As such, answer terms with a confidence score less than 50% will not be considered informative, and will be excluded from the list of informative factoid answers that create the new knowledge base entry.

Next, at 204, the factoid answer collection program 110a, 110b identifies a query from a user. On the screen of the QA system, there may be a dialog box, for example, in which the user may enter a query. Using a software program 108 on the user's device (e.g., user's computer 102), the QA system may transmit, over the communications network 116, the query to the factoid answer collection program 110a, 110b to create new knowledge base entries based on the answer terms that are related to the received query. Then, the query may be received as an input into the factoid answer collection program 110a, 110b. The query may be in various forms, such as natural language, Boolean search or keyword search. The query may be related to a broad range of domains. The received query may then be entered into an answer generator that may generate multiple answer terms to the received query. The criteria for informativeness 202 may be utilized to determine the informativeness of each generated answer term.

Additionally, depending on the QA system utilized by the user, the user may enter multiple queries at one time, or in a rapid succession using an application program interface (API), which may be transmitted to the factoid answer collection program 110a, 110b.

Continuing the previous example, the factoid answer collection program 110a, 110b identifies the following query as a text string from the user: Who landed in America on Feb. 7, 1964? The factoid answer collection program 110a, 110b also retrieves the following answer terms to the received query from the answer generator:
Answer 1: Ringo Starr (65%)
Answer 2: Paul McCartney (62%)
Answer 3: George Harrison (61%)
Answer 4: John Lennon (60%)
Answer 5: Pete Best (53%)
Answer 6: British Stony Road ice cream (43%)

Based on the previously defined criteria for informativeness, only answer terms with a high-confidence score above 50% may be utilized to satisfy the criteria for informativeness. As such, the following answer term may be excluded from the list of informative factoid answers to the received query:
Answer 6: British Stony Road ice cream (43%)

The following answer terms satisfy the previously defined criteria for informativeness and may be included in the list of informative factoid answers to the received query:
Answer 1: Ringo Starr (65%)
Answer 2: Paul McCartney (62%)
Answer 3: George Harrison (61%)
Answer 4: John Lennon (60%)
Answer 5: Pete Best (53%)

In another embodiment, if the answer generator fails to retrieve at least one possible factoid answer to the identified query 204, then the user may receive an error message. The user may then enter the same query, a variation of the same query, or a different query for the answer generator to generate answer terms for the factoid answer collection program 110a, 110b to generate informative factoid answers to the query.

Then, at 206, the factoid answer collection program 110a, 110b identifies relation-bearing elements in the query. To identify relation-bearing elements (i.e., noun phrases) in the received query, the factoid answer collection program 110a, 110b may utilize semantic categories, or may decompose the received query into the identified relation-bearing elements. The QA system may identify semantic categories (e.g., all named entities) from the received query. The factoid answer collection program 110a, 110b may then utilize the semantic categories to identify the relation-bearing elements (i.e., noun phrases). Alternatively, to decompose the received query, the factoid answer collection program 110a, 110b may use syntactic parse (i.e., to identify grammatical components), semantic classifiers (i.e., to identify classes using taxonomy, dictionary look-up, or additional natural language processing), or lexical answer types (LAT) identification. The relation-bearing elements may be derived from the decomposed query.

Continuing the previous example, two noun phrases, Feb. 7, 1964 and America, are included in the received query. Therefore, Feb. 7, 1964 and America are the identified relation-bearing elements in the received query, who landed in America on Feb. 7, 1964?

Then, at 208, the factoid answer collection program 110a, 110b groups the informative factoid answers into a single object. The answer terms that fail to satisfy the criteria of informativeness may be removed from the generated list of answer terms, and the remaining answer terms (i.e., informative factoid answers) may be grouped together as a single object. Since these informative factoid answers satisfy the criteria for informativeness, the factoid answer collection program 110a, 110b determines that the informative factoid answers may possess sufficient semantic similarity to be grouped as a single object. Depending on the QA system utilized to generate the answer terms, the factoid answer collection program 110a, 110b may utilize various techniques to group the informative factoid answers (e.g., string concatenation, vectors, or relate each informative answer term to the others by way of the relation-bearing element from the query).

Continuing the previous example, based on the QA system utilized to generate the answer terms, string concatenation will be utilized to group the informative factoid answers into a single object. As such, a comma will be utilized to separate the informative factoid answers grouped into a single object. The informative factoid answers are grouped as follows:
Ringo Starr, Paul McCartney, George Harrison, John Lennon, Pete Best

Then, at 210, the factoid answer collection program 110a, 110b generates relation between the informative factoid answers group and relation-bearing elements from the query, and stores the output into the knowledge base 212 (i.e., database 114). A relation name or label may be generated to identify the relationship between the informative factoid answers group and the relation-bearing elements from the query (i.e, objects for RDF Triples or nodes for knowledge graph). If two or more relation-bearing elements in the query are generated, then the relation may be generated for each relation-bearing element since the relation-bearing element may be the anchor created for each knowledge base entry. The factoid answer collection program 110a, 110b may utilize various techniques (e.g., RDF Triples and knowledge graph) to represent the relation. A technique may be utilized to represent the relation as long as the technique is acceptable to the knowledge base since the relation name along with the informative factoid answers group and the relation-bearing elements from the query may be stored as a new entry in the knowledge base 212 along with an annotation as to whether the information is derived or direct (e.g., first-hand information). Such an annotation may determine how the information is utilized if the information is returned in subsequent queries.

Continuing the previous example, based on the QA system utilized to generate the answer terms, RDF Triples may be utilized to generate the relation to be stored in the knowledge base 212. The relations are generated and the two new entries to be stored in the knowledge base 212 are as follows:

### Knowledge Base Entry A:

[Feb. 7, 1964/DATE personRel Ringo Starr, Paul McCartney, George Harrison, John Lennon, Pete Best/PERSON]

### Knowledge Base Entry B:

[America /PLACE personRel Ringo Starr, Paul McCartney, George Harrison, John Lennon, Pete Best/PERSON]

In knowledge base entry A, the first object (e.g., Feb. 7, 1964) is the relation-bearing element in the query that relates the date presented in the query, and the second object (e.g., Ringo Starr, Paul McCartney, George Harrison, John Lennon, Pete Best) are the informative factoid answers that are people related to the date presented in the query.

Similarly, in knowledge base entry B, the first object (e.g., America) is the relation-bearing element in the query that relates the place or location presented in the query, and the second object (e.g., Ringo Starr, Paul McCartney, George Harrison, John Lennon, Pete Best) are the informative factoid answers that are people related to the place or location presented in the query. For both knowledge base entries, the relation name (e.g., personRel) identifies the relation between the two objects.

In this example, the informative factoid answers generated by the answer generator are strung together and the relation name identifies that the names of the people included in the second object (e.g., Ringo Starr, Paul McCartney, George Harrison, John Lennon, Pete Best) possess a semantically similar relationship with the date or place in the first object (e.g., Feb. 7, 1964 or America). The generated relation is stored in the knowledge base 212 along with an annotation that the information is derived, and may be generated for future queries related to Feb. 7, 1964 or America.

In the present embodiment, if the factoid answer collection program 110a, 110b determines that the most informative factoid answers fail to answer the query and are semantically distinct, then the factoid answer collection program 110a, 110b may place the informative factoid answers into a generic relation as follows:
[Feb. 7, 1964/DATE signficantRel Ringo Starr, Paul McCartney, George Harrison, John Lennon, Pete Best/PERSON]
   This relation may indicate that the factoid answer collection program 110a, 110b may have received high informativeness for these names and when combined together, these names have some significance. Since the relation is unknown, the new entry may be stored in the knowledge base 212, and the user may have to determine the relationship between the generated answer terms and the relation-bearing element in the query at a later date.

In the present embodiment, the factoid answer collection program 110a, 110b may become more specific based on the queries entered as input by the user. The factoid answer collection program 110a, 110b may develop a user adapted knowledge base based on the generated queries from the user. For example, if the user only enters queries on the music trivia, then the knowledge base 212 may be primarily generated with information related to music trivia.

In the present embodiment, the new knowledge base entries generated by the received query may be stored in the knowledge base 212. The QA system may then present the informative factoid answers to the received query to the user. If the QA system receives a query, at a later date, in which the factoid answer collection program 110a, 110b already generated the informative factoid answers to the query, then the QA system may retrieve the appropriate informative factoid answers from the knowledge base 212 and present the appropriate informative factoid answers to the user.

It may be appreciated that FIG. 2 provides only an illustration of one embodiment and does not imply any limitations with regard to how different embodiments may be implemented. Many modifications to the depicted embodiment(s) may be made based on design and implementation requirements.

FIG. 3 is a block diagram 900 of internal and external components of computers depicted in FIG. 1 in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902a, b and external components 904a, b illustrated in FIG. 3. Each of the sets of internal components 902a, b includes one or more processors 906, one or more computer-readable RAMs 908, and one or more computer-readable ROMs 910 on one or more buses 912, and one or more operating systems 914 and one or more computer-readable tangible storage devices 916. The one or more operating systems 914, the software program 108 and the factoid answer collection program 110a in client computer 102, and the factoid answer collection program 110b in network server 112, may be stored on one or more computer-readable tangible storage devices 916 for execution by one or more processors 906 via one or more RAMs 908 (which typically include cache memory). In the embodiment illustrated in FIG. 3, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the factoid answer collection program 110a and 110b can be stored on one or more of the respective portable computer-readable tangible storage devices 920, read via the respective R/W drive or interface 918, and loaded into the respective hard drive 916.

Each set of internal components 902a, b may also include network adapters (or switch port cards) or interfaces 922 such as a TCP/IP adapter cards, wireless Wi-Fi interface cards, or 3G or 4G wireless interface cards or other wired or wireless communication links. The software program 108 and the factoid answer collection program 110a in client computer 102 and the factoid answer collection program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the factoid answer collection program 110a in client computer 102 and the factoid answer collection program 110b in network server computer 112 are loaded into the respective hard drive 916. The network may comprise copper wires, optical fibers, wireless transmission, routers, firewalls, switches, gateway computers and/or edge servers.

Each of the sets of external components 904a, b can include a computer display monitor 924, a keyboard 926, and a computer mouse 928. External components 904a, b can also include touch screens, virtual keyboards, touch pads, pointing devices, and other human interface devices. Each of the sets of internal components 902a, b also includes device drivers 930 to interface to computer display monitor 924, keyboard 926, and computer mouse 928. The device drivers 930, R/W drive or interface 918, and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

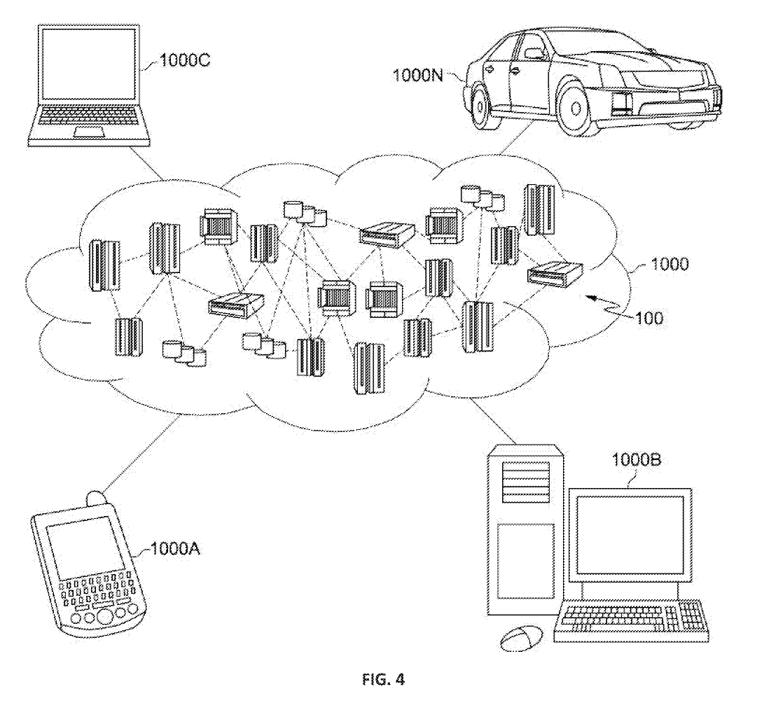

Referring now to FIG. 4, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 4 are intended to be illustrative only and that computing nodes 100 and cloud computing environment 1000 can communicate with any type of computerized device over any type of network and/or network addressable connection (e.g., using a web browser).

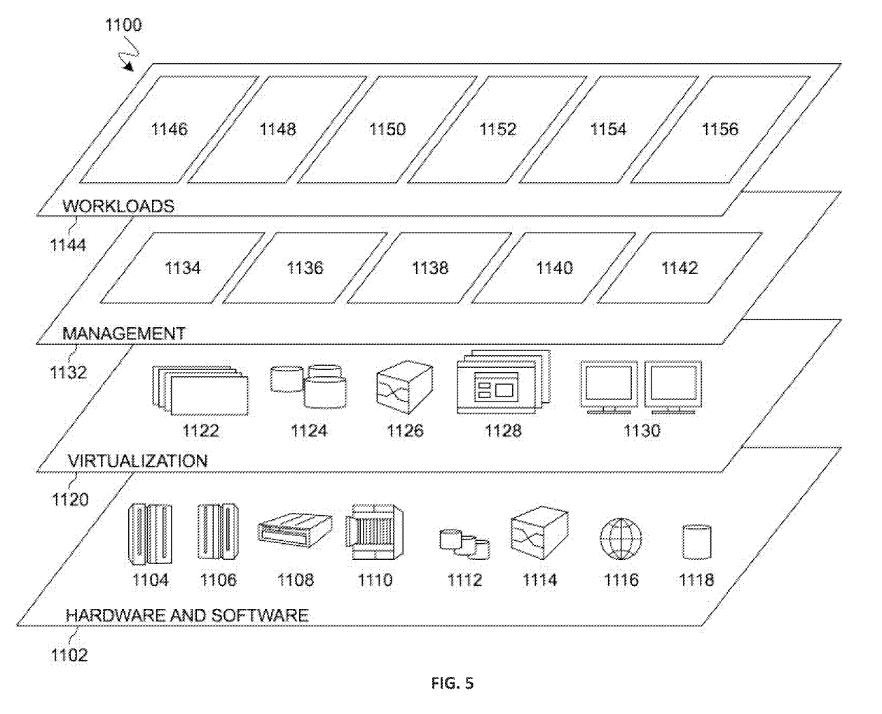

Referring now to FIG. 5, a set of functional abstraction layers 1100 provided by cloud computing environment 1000 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and factoid answer collection 1156. A factoid answer collection program 110a, 110b provides a way to collect related factoid answers into a single object.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for collecting related factoid answers into a single object, the method comprising:
identifying an informativeness criteria;
identifying a query entered by a user;
receiving a plurality of answer terms generated by an answer generator;
generating a plurality of informative factoid answers based on the received plurality of answer terms to the identified query;
identifying a plurality of relation-bearing elements based on the identified query;
grouping the generated plurality of informative factoid answers into a single object, wherein the generated plurality of informative factoid answers is derived from the received plurality of answer terms;
generating a plurality of relations from the grouped plurality of informative factoid answers and the corresponding identified plurality of relation-bearing elements;
creating a plurality of knowledge base entries from the generated plurality of relations; and
storing the created plurality of knowledge entries in a knowledge base.

2. The method of claim 1, wherein identifying the query by the user, further comprises:
decomposing the identified query; and
generating the identified plurality of relation-bearing elements based on the decomposed query.

3. The method of claim 1, wherein identifying the informativeness criteria, further comprises:
identifying the criteria for informativeness selected by the user;
determining that the criteria for informativeness is based on a numeric value;
receiving, from the user, a threshold for the identified criteria for informativeness with a numeric value; and
associating the received threshold with the identified criteria for informativeness with a numeric value.

4. The method of claim 1, further comprising:
assessing the identified plurality of answers terms with the identified informativeness criteria;
filtering the assessed plurality of answer terms from the received query based on the identified informativeness criteria; and
generating the plurality of informative factoid answers from the filtered plurality of answer terms.

5. The method of claim 1, wherein grouping the plurality of informative factoid answers into the single object, wherein the generated plurality of informative factoid answers is derived from the received plurality of answer terms, further comprises:
determining an acceptable method for grouping the plurality of informative factoid answers into a single object based on the answer generator utilized to generate the identified plurality of answer terms; and
grouping the plurality of informative factoid answers into a single object based on the determined acceptable method for grouping the plurality of informative factoid answers.

6. The method of claim 1, further comprising:
determining the grouped plurality of informative factoid answers are semantically different and fail to answer the received query; and
generating a plurality of generic relations with the determined plurality of informative factoid answers and the corresponding identified plurality of relation-bearing elements.

7. The method of claim 6, further comprising:
generating a plurality of generic knowledge base entries based on the generated plurality of generic relations;
storing the generated plurality of generic knowledge base entries in the knowledge base; and
presenting the stored plurality of generic knowledge base entries to the user.

8. A computer system for collecting related factoid answers into a single object, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
identifying an informativeness criteria;
identifying a query entered by a user;
receiving a plurality of answer terms generated by an answer generator;
generating a plurality of informative factoid answers based on the received plurality of answer terms to the identified query;
identifying a plurality of relation-bearing elements based on the identified query;
grouping the generated plurality of informative factoid answers into a single object, wherein the generated plurality of informative factoid answers is derived from the received plurality of answer terms;
generating a plurality of relations from the grouped plurality of informative factoid answers and the corresponding identified plurality of relation-bearing elements;
creating a plurality of knowledge base entries from the generated plurality of relations; and
storing the created plurality of knowledge entries in a knowledge base.

9. The computer system of claim 8, wherein identifying the query by the user, further comprises:
decomposing the identified query; and
generating the identified plurality of relation-bearing elements based on the decomposed query.

10. The computer system of claim 8, wherein identifying the informativeness criteria, further comprises:
identifying the criteria for informativeness selected by the user;
determining that the criteria for informativeness is based on a numeric value;
receiving, from the user, a threshold for the identified criteria for informativeness with a numeric value; and
associating the received threshold with the identified criteria for informativeness with a numeric value.

11. The computer system of claim 8, further comprising:
assessing the identified plurality of answers terms with the identified informativeness criteria;
filtering the assessed plurality of answer terms from the received query based on the identified informativeness criteria; and
generating the plurality of informative factoid answers from the filtered plurality of answer terms.

12. The computer system of claim 8, wherein grouping the plurality of informative factoid answers into the single object, wherein the generated plurality of informative factoid answers is derived from the received plurality of answer terms, further comprises:
determining an acceptable method for grouping the plurality of informative factoid answers into a single object based on the answer generator utilized to generate the identified plurality of answer terms; and
grouping the plurality of informative factoid answers into a single object based on the determined acceptable method for grouping the plurality of informative factoid answers.

13. The computer system of claim 8, further comprising:
determining the grouped plurality of informative factoid answers are semantically different and fail to answer the received query; and
generating a plurality of generic relations with the determined plurality of informative factoid answers and the corresponding identified plurality of relation-bearing elements.

14. The computer system of claim 13, further comprising:
generating a plurality of generic knowledge base entries based on the generated plurality of generic relations;
storing the generated plurality of generic knowledge base entries in the knowledge base; and
presenting the stored plurality of generic knowledge base entries to the user.

15. A computer program product for collecting related factoid answers into a single object, comprising:
one or more computer-readable storage medium and program instructions stored on at least one of the one or more tangible storage medium, the program instructions executable by a processor, the program instructions comprising:
program instructions to identify an informativeness criteria;
program instructions to identify a query entered by a user;
program instructions to receive a plurality of answer terms generated by an answer generator;
program instructions to generate a plurality of informative factoid answers based on the received plurality of answer terms to the identified query;
program instructions to identify a plurality of relation-bearing elements based on the identified query;
program instructions to group the generated plurality of informative factoid answers into a single object, wherein the generated plurality of informative factoid answers is derived from the received plurality of answer terms;
program instructions to generate a plurality of relations from the grouped plurality of informative factoid answers and the corresponding identified plurality of relation-bearing elements;
program instructions to create a plurality of knowledge base entries from the generated plurality of relations; and
program instructions to store the created plurality of knowledge entries in a knowledge base.

16. The computer program product of claim 15, wherein program instructions to identify the query by the user, further comprises:
program instructions to decompose the identified query; and
program instructions to generate the identified plurality of relation-bearing elements based on the decomposed query.

17. The computer program product of claim 15, wherein program instructions to identify the informativeness criteria, further comprises:
program instructions to identify the criteria for informativeness selected by the user;
program instructions to determine that the criteria for informativeness is based on a numeric value;
program instructions to receive, from the user, a threshold for the identified criteria for informativeness with a numeric value; and
program instructions to associate the received threshold with the identified criteria for informativeness with a numeric value.

18. The computer program product of claim 15, further comprising:
program instructions to assess the identified plurality of answers terms with the identified informativeness criteria;
program instructions to filter the assessed plurality of answer terms from the received query based on the identified informativeness criteria; and
program instructions to generate the plurality of informative factoid answers from the filtered plurality of answer terms.

19. The computer program product of claim 15, wherein program instructions to group the plurality of informative factoid answers into the single object, wherein the generated plurality of informative factoid answers is derived from the received plurality of answer terms, further comprises:
program instructions to determine an acceptable method for grouping the plurality of informative factoid answers into a single object based on the answer generator utilized to generate the identified plurality of answer terms; and
program instructions to group the plurality of informative factoid answers into a single object based on the determined acceptable method for grouping the plurality of informative factoid answers.

20. The computer program product of claim 15, further comprising:
program instructions to determine the grouped plurality of informative factoid answers are semantically different and fail to answer the received query; and
program instructions to generate a plurality of generic relations with the determined plurality of informative factoid answers and the corresponding identified plurality of relation-bearing elements.
